(19) United States
(12) Patent Application Publication
(10) Pub. No.: US 2012/0127902 A1
(43) Pub. Date: May 24, 2012

(54) SYSTEM AND METHOD FOR MAC LAYER CLOCK DRIFT COMPENSATION

(76) Inventor: ALAA MUQATTASH, San Diego, CA (US)

(21) Appl. No.: 12/953,336

(22) Filed: Nov. 23, 2010

(51) Int. Cl. H04W 52/02

(52) U.S. Cl. 370/311

(57) ABSTRACT

A system and method allows a slave device to avoid the potential energy dissipation that might otherwise result from remaining in receive mode for long enough to account for worst-case clock drift. A master device is configured to transmit a plurality of beacons during a time interval determined according to possible clock drift between the master and slave device. When the slave device wakes, it receives a beacon of the plurality. Accordingly, the slave device can save power by minimizing the time it is required to spend in receive mode.

### TECHNICAL FIELD

The present invention relates generally to communication networks, and more particularly, some embodiments relate to clock drift compensation at the MAC layer.

### DESCRIPTION OF THE RELATED ART

In some wireless systems, communications occur between master devices and slave devices. The master device transmits beacons to the slave device and the slave device listens for such beacons to initiate communications. In various systems, beacons may include information such as data transmission parameters, data channels that can be used by the slave device, the time at which the slave device can initiate its communication with the master device, whether or not the master device has some data to send to the slave device quality of service (QOS) capabilities, the beacon interval duration, and traffic indication messages.

In these systems, each master and slave device implements a counter (i.e. a clock) to keep track of time based on its internal oscillator. Such a clock is used for the correct functionality of the MAC layer protocol. For example, to correctly receive a beacon, a slave device enters a reception state at the correct time. Every oscillator has a limited accuracy (described by frequency error measured in parts per million (ppm), for example, a clock might have an accuracy of 50 pm). Because of this, any two clocks, such as the clocks in the master and slave devices, that were once synchronized will eventually lose synchronization.

Some wireless systems, for example low power sensor networks, have long beacon intervals between sequential beacon transmissions. For example, some wireless systems may have around a 5 second interval between beacons. Often, the slave device or the radio subsystem of the slave device will enter a low power mode between beacons. During the low power mode, it is often desirable to use very low power oscillators, such as a 32 KHz RC oscillator. Although such clocks use a very low current (on the order of nA), they have low accuracy, typically around 200 ppm. In such cases the clock drift between the devices can be around 2,000 μs. This is a significant clock drift that can result in the slave missing the transmission of the beacon from the master. FIG. 1 illustrates this situation. A master device transmits a beacon 105 after a beacon interval 100. If the slave's clock is too slow 101, clock drift can result in the slave entering a receive state 102 after the beacon 105 has been transmitted. If the slave's clock is too fast 103, clock drift results in the slave entering and exiting the receive state 104 before the beacon 105 is transmitted. Traditionally, this problem is solved by requiring the slave device to remain in the receive state 106 for long enough to compensate for the worst case clock drift 105 between the devices.

### BRIEF SUMMARY OF EMBODIMENTS OF THE INVENTION

According to various embodiments of the invention, a system and method is provided that allows a slave device to avoid the potential energy dissipation that might otherwise result from remaining in receive mode for long enough to account for worst-case clock drift. A master device is configured to transmit a plurality of beacons during a time interval determined according to possible clock drift between the master and slave device. Accordingly, the receiving device can save power by minimizing the time it is required to spend in receive mode.

In one embodiment of the invention, a method of network communications, comprises a beacon sending device transmitting a plurality of beacons for the beacon receiving device during a predetermined time interval in which a beacon receiving device exits a low power mode to receive a beacon of the plurality of beacons; the beacon receiving device exiting the low power mode at a time within the predetermined time interval, wherein, before the time, the beacon sending device does not know when the beacon receiving device will exit the low power mode; the beacon receiving device receiving the beacon of the plurality of beacons; the beacon sending device entering a reception state to receive a response from the beacon receiving device to the received beacon of the plurality of beacons; the beacon receiving device transmitting the response to the beacon sending device; and the beacon receiving device re-entering the low power mode.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates a prior art method of clock drift compensation.

FIG. 2 illustrates a method of clock drift compensation implemented in accordance with an embodiment of the invention.

FIG. 3 illustrates a method of clock drift compensation implemented in accordance with an embodiment of the invention.

FIG. 4 illustrates an example computing module that may be used in implementing various features of embodiments of the invention.

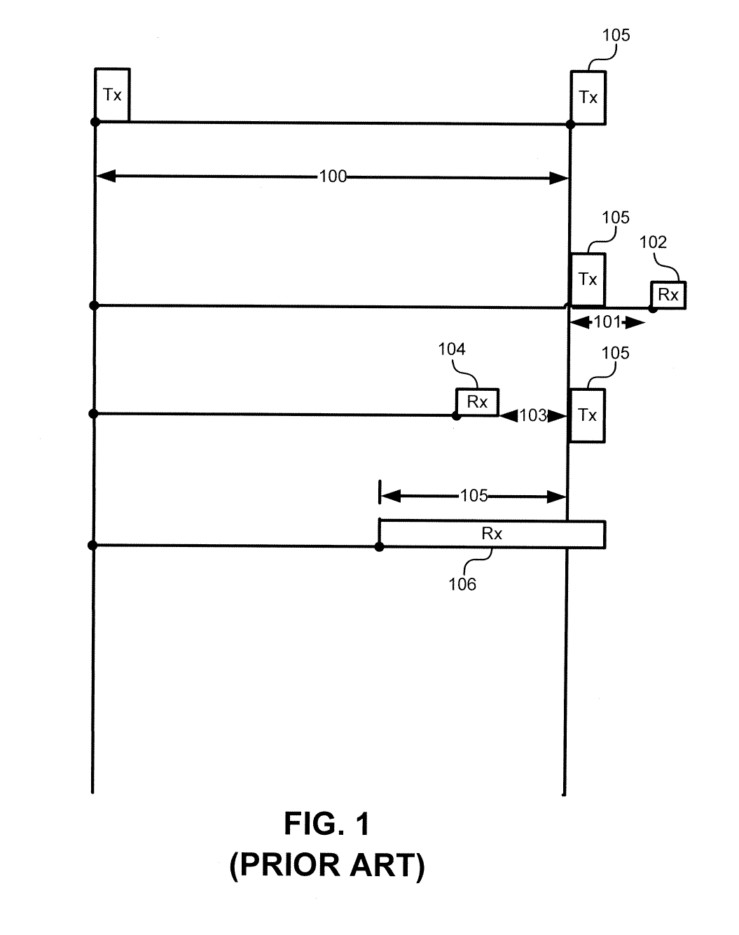

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward a system and method for MAC layer clock compensation for beacon transmission between a beacon sending device, such as a master device, and a beacon receiving device, such as a slave device.

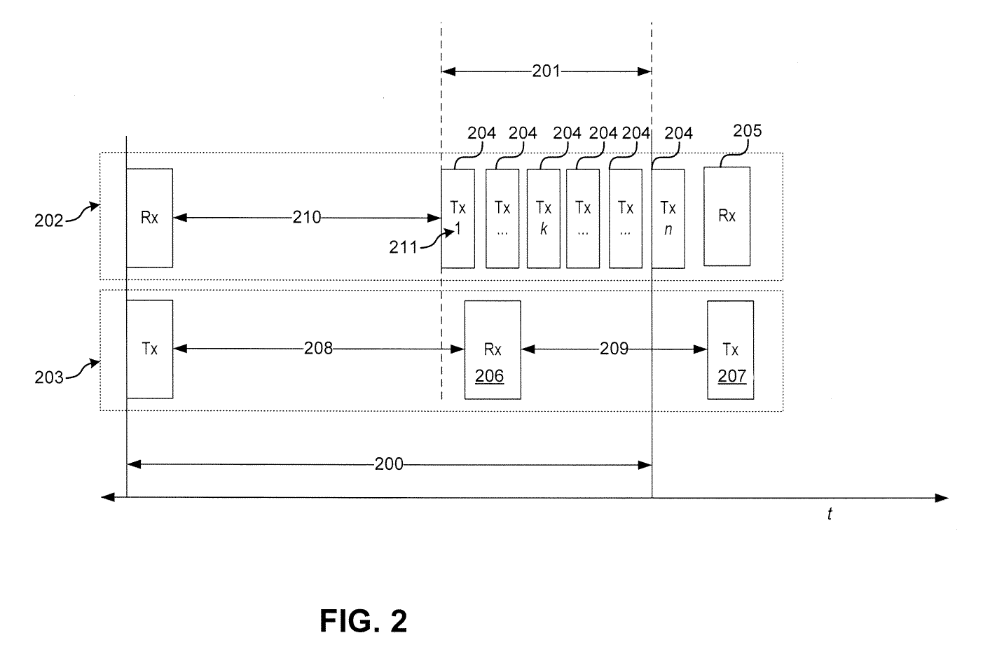

FIG. 2 illustrates a method of MAC layer clock drift compensation implemented in accordance with an embodiment of the invention. Block 202 illustrates the operations conducted by a beacon sending device, while block 203 illustrates the operations conducted by a beacon receiving device. In the illustrated communication system, a beacon sending device is in charge of initiating communications with a beacon receiving device. Communications are divided into beacon intervals 200, determined according to the time between sequential beacon transmissions. In various embodiments, the beacons provide the means for medium access control (MAC) between the beacon receiving device and beacon sending device. The beacons may include information for maintaining the link between the beacon sending device and the beacon receiving device, exchanging timing information, and scheduling information for data transmission between the beacon sending device and the beacon receiving device.

In some embodiments, the beacon sending device and the beacon receiving device have asymmetric resources and requirements. For example, the beacon receiving device may comprise a low power slave device, where long times between power recharges is desired. The beacon sending device may comprise a device with a larger power budget, such as a master device that is more accessible for more frequent recharges, or is equipped with a larger power source. For example, the beacon receiving device may be a low power sensor operating in a slave mode, and the beacon sending device may comprise a base station to which the sensor sends data.

In the illustrated embodiment, the beacon receiving device 203 is configured to enter a lower power state 208 during the beacon interval 200, and awaken to enter a receive state 206 to receive a beacon 204 from the beacon sending device 202. The beacon sending device 202 maintains a clock-based counter that enables timing related functions, such as when to transmit beacons 201 and when to enter a receive state 205 to receive a response to the beacons 204 from the beacon sending device 203. Likewise, the beacon sending device 203 maintains a clock-based counter that allows it to enter a receive state 206 to receive a beacon 204 and to transmit 207 a response while the beacon sending device 202 is in receive state 205. Due to clock drift between the beacon sending device 202 and the beacon receiving device 203, the two devices will differ on their measurement of the beacon interval 200. Accordingly, the beacon receiving device 203 will wake up 206 at some time during an interval 201 near a scheduled time for a beacon transmission. Since the clock systems used by beacon sending device 202 and beacon receiving device 203 and the beacon interval length 200 are known, the length of the time interval 201 may be predetermined. During any given beacon interval, the beacon receiving device 203 will wake up at some time within that interval to receive 206 a beacon 204. This time will generally be a result of actual clock drift occurring between the beacon sending device 202 and the beacon receiving device 203 during the given beacon interval. Accordingly, the actual time at which the beacon receiving device 203 will wake up may be unknown by the beacon sending device 202.

In the illustrated embodiment, the beacon sending device 202 uses its clock to measure the beacon interval 200. After a predetermined period 210, before a time interval 201 defined according to possible clock drift that may occur between the devices, the beacon sending device 202 begins sending a plurality of beacons 204 for beacon receiving device 203. Each beacon 204 contains substantially similar beacon information as the other beacons, and, particularly, each is addressed to the beacon receiving device 203. For example, each beacon 204 may contain substantially the same beacon information except for an index 211 that differs between beacons 204. In some embodiments, the beacons 204 are transmitted to cover the interval 201 contiguously. In other embodiments, the plurality of beacons 204 may be spaced apart within the interval as a compromise between sending device power consumption and receiving device power consumption. For example, beacon sending device 202 might send one beacon 204 in the middle of interval 201 and a second one at the end of interval 201. In the illustrated embodiment, each beacon further includes an index 211. At a predetermined time after sending the last beacon 204, the beacon sending device 202 enters a reception state 205 to receive a beacon response 207 from the beacon receiving device 203.

The beacon receiving device exits a low power mode after a time 208, which represents the beacon receiving device 203 measuring the beacon interval 200 with an inaccurate clock. For example, the beacon receiving device 203 may enter a low power sleep or hibernation mode during the hibernation time 208, and may implement a low power, low accuracy clock, such as a simple RC resonator. After exiting the power save mode, the device 203 enters a reception state 206 until it receives a beacon 204. Because the beacon sending device 202 transmits a plurality of beacons 204, the receive period 206 may be significantly shorter than if the beacon receiving device 203 had to wait until the end of period 200 to receive a beacon. In the illustrated embodiment, the beacons 204 are indexed 211. Accordingly, the beacon receiving device 203 is able to receive the index 211 from the received beacon 204. The beacon receiving device is configured to use the index 211 to determine how long 209 until the beacon sending device 205 will enter the receive state. The beacon receiving device 203 may then enter a reduced power mode, which may comprise the same low power state as period 208, or may comprise a reduced power mode where the radio receiver is powered down, but the device continues to implement some increased functionality, such as a more accurate receiver clock. In typical embodiments, time period 209 is significantly less than time period 208, such that clock drift will not result in the beacon sending device 202 missing the response 207. However, if clock drift during period 209 becomes an issue, then the sending device 202 may enter receive state 205 early and remain in it long enough to compensate for possible clock drift during period 209. If there are further communications, they occur as scheduled by the beacon sending device 202. Otherwise, the beacon receiving device 203 enters the low power mode until the next beaconing time and the devices repeat the above process.

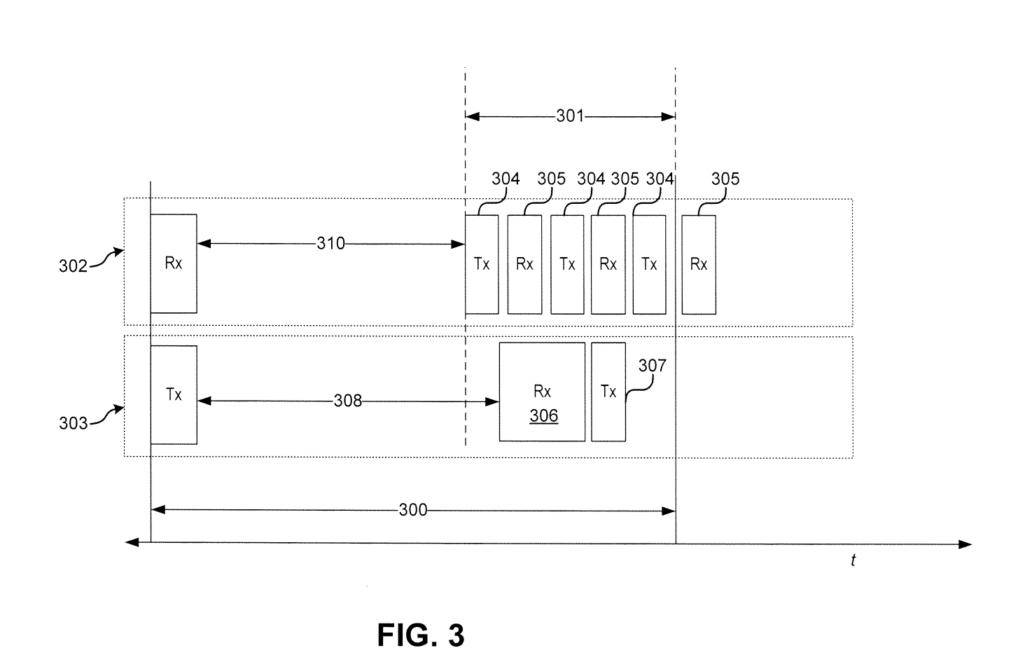

FIG. 3 illustrates another method of MAC layer clock drift compensation implemented in accordance with an embodiment of the invention. The method illustrated in FIG. 3 is similar to that of FIG. 2. The length of beacon interval 300 is determined by the transmission of beacons 304. Time interval 301 is a predetermined duration that covers the possible times for beacon receiving device 303 to awaken from low power mode. After a time 310 since the last transmission and beginning at the start of time interval 301, the beacon sending device 302 transmits a plurality of beacons 304 throughout the interval 301, such that a beacon receiving device 303 will receive a beacon shortly after waking from a low power state. After time 308, the beacon receiving device 303 awakens at some time during interval 301. In this embodiment, after each beacon transmission 304, the beacon sending device 302 enters a receive state 305 to receive a beacon response 307 from beacon receiving device 303. Because the wake-up time of the beacon receiving device 303 may fall within a beacon response reception period 305, the total receive time 306 for the receiving device 303 may be on average longer than in the method of FIG. 2. However, in this embodiment the beacon receiving device 303 may quickly transmit response 307.

In the illustrated embodiment, a beacon response reception period 305 follows each beacon 304. Accordingly, the beacon receiving device 303 may transmit a response 307 immediately subsequently after receiving a beacon 304 during reception period 306. In other embodiments, the beacon sending device 302 may enter the receive state 305 after transmitting more than one beacon 304. For example, the beacon sending device 302 could enter receive state 305 every two beacons 304, or so on. In these embodiment, the beacon receiving device 303 may be configured to enter a short low power mode, or deactivate the receiver, while waiting for the next available reception period.

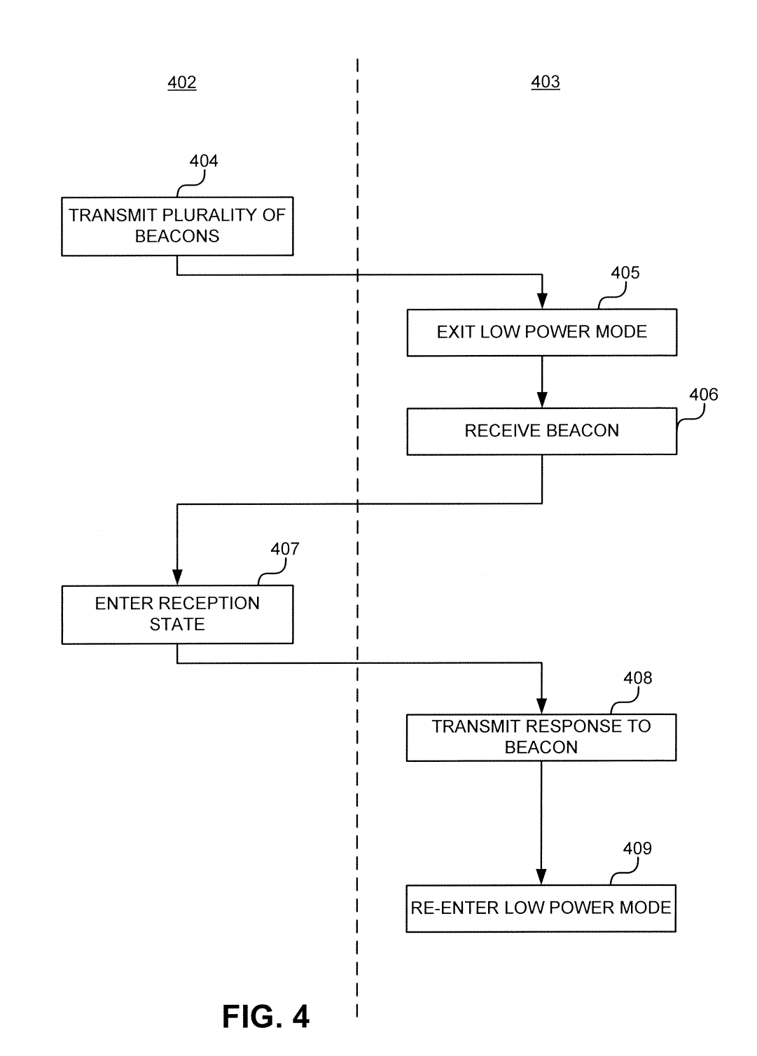

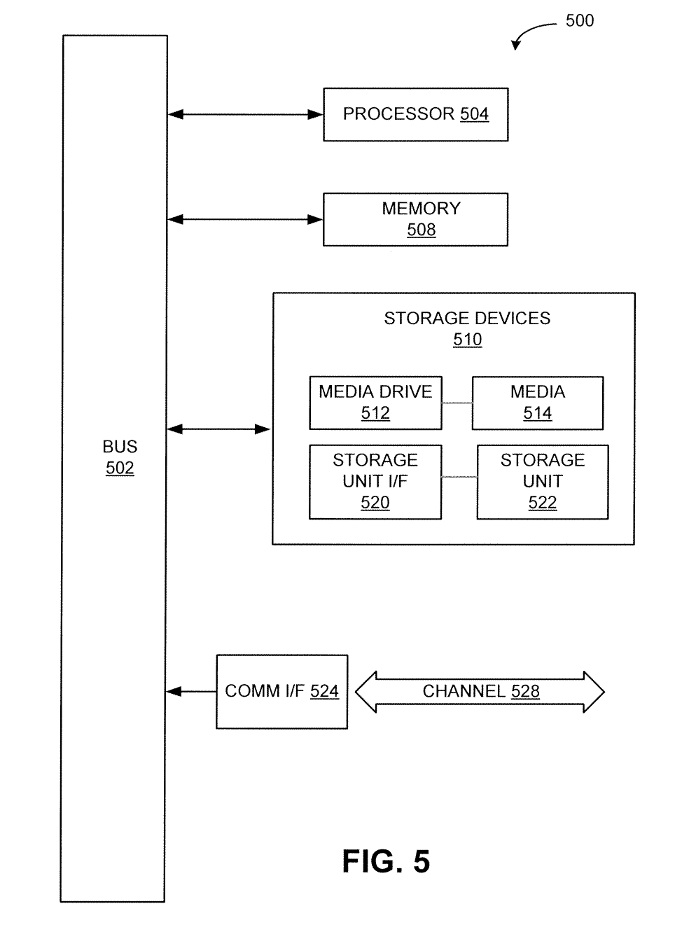

FIG. 4 is a flow chart illustrates an embodiment of the invention. In the illustrated embodiment a beacon transmitting device 402 transmits beacons to a beacon receiving device 403. Beacon receiving device enters a low power mode such as a hibernation mode in-between beacon intervals. During the low power mode, there is clock drift between beacons sending device 402 and beacon receiving device 403. As a result of the clock drift, the beacon sending device 402 does not know the precise time at which the beacon receiving device 403 will wake to receive a beacon. However, a range of typical clock drift values may be determined, this range may be used to establish a predetermined time interval around a scheduled beacon interval in which the beacon receiving device 403 will wake.

In the illustrated embodiment, the beacon sending device 402 transmits 404 a plurality of beacons for the beacon receiving device during a predetermined time interval in which a beacon receiving device exits a low power mode to receive a beacon of the plurality of beacons. As discussed above, in some embodiments, this predetermine time interval may be determined by the beacon sending device according to possible clock drift between the beacon receiving device and the beacon sending device occurring while the beacon receiving device is in the low power mode.

In step 405, the beacon receiving device 403 exits the low power mode. In this embodiment, the beacon receiving device exits the low power mode at a time within the predetermined time interval, and before the time, the beacon sending device does not know when the beacon receiving device will exit the low power mode. For example, the time within the predetermined time interval may be a result of actual clock drift between the beacon receiving device and the beacon sending device occurring while the beacon receiving device is in the low power mode.

In step 406, the beacon receiving device 403 receives a beacon of the plurality of beacons transmitted by the beacon sending device 402. In various embodiments, the beacons may contain any typical beacon information such as data transmission parameters, data channels that can be used by the slave device, the time at which the slave device can initiate its communication with the master device, whether or not the master device has some data to send to the slave device quality of service (QOS) capabilities, the beacon interval duration, and traffic indication messages. In further embodiments, as discussed above, the beacons may include identifying indices that allow the beacon receiving device 403 to identify how many beacons are remaining, and allow the beacon receiving device 403 to identify when it should transmit a response to the received beacon.

In step 407, the beacon sending device 402 enters a reception state to receive a response to the beacon from the beacon receiving device 403. As discussed above, in some embodiments, the reception state may be a scheduled reception state that occurs after the predetermined interval. In other embodiments, the reception state may be one of a plurality of reception states that are entered during the predetermined interval. For example, the beacon sending device 402 may enter a reception state after each beacon transmission.

In step 408, the beacon receiving device sends a response to the beacon to the beacon sending device 402. If there is data to be transmitted from one device to the other, then this data may be transmitted through the beacons or the beacons may be used to schedule a time for the data exchange. After transmitting the response, and after exchanging data if applicable, the beacon receiving device 403 re-enters the low power mode 409 until the next beacon period.

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 5. Various embodiments are described in terms of this example-computing module 500. After reading this description, it will become apparent to a person skilled in the relevant art how to implement the invention using other computing modules or architectures.

Referring now to FIG. 5, computing module 500 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally.

Computing module 500 might also include one or more memory modules, simply referred to herein as main memory 508. For example, preferably random access memory (RAM) or other dynamic memory, might be used for storing information and instructions to be executed by processor 504. Main memory 508 might also be used for storing temporary variables or other intermediate information during execution of instructions to be executed by processor 504. Computing module 500 might likewise include a read only memory (“ROM”) or other static storage device coupled to bus 502 for storing static information and instructions for processor 504.

The computing module 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a floppy disk drive, a magnetic tape drive, an optical disk drive, a CD or DVD drive (R or RW), or other removable or fixed media drive might be provided. Accordingly, storage media 514 might include, for example, a hard disk, a floppy disk, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing module 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory module) and memory slot, a PCMCIA slot and card, and other fixed or removable storage units 522 and interfaces 520 that allow software and data to be transferred from the storage unit 522 to computing module 500.

Computing module 500 might also include a communications interface 524. Communications interface 524 might be used to allow software and data to be transferred between computing module 500 and external devices. Examples of communications interface 524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 524 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium,” “computer usable medium,” and “computer readable medium” are used to generally refer to media such as, for example, memory 508, storage unit 520, media 514, and channel 528, and may include non-transitory computer usable media. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 5 00 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method of network communications, comprising:
a beacon sending device transmitting a plurality of beacons for the beacon receiving device during a predetermined time interval in which a beacon receiving device exits a low power mode to receive a beacon of the plurality of beacons;
the beacon receiving device exiting the low power mode at a time within the predetermined time interval, wherein, before the time, the beacon sending device does not know when the beacon receiving device will exit the low power mode;
the beacon receiving device receiving the beacon of the plurality of beacons;
the beacon sending device entering a reception state to receive a response from the beacon receiving device to the received beacon of the plurality of beacons;
the beacon receiving device transmitting the response to the beacon sending device; and
the beacon receiving device re-entering the low power mode.

2. The method of claim 1, wherein predetermined time interval is determined by the beacon sending device according to possible clock drift between the beacon receiving device and the beacon sending device occurring while the beacon receiving device is in the low power mode.

3. The method of claim 2, wherein the time when the beacon receiving device exits the low power mode is a result of actual clock drift between the beacon receiving device and the beacon sending device occurring while the beacon receiving device is in the low power mode.

4. The method of claim 1, wherein each beacon of the plurality of beacons includes an identifying index.

5. The method of claim 4, wherein the beacon sending device enters the reception state after the predetermined time interval.

6. The method of claim 5, wherein the beacon receiving device enters a power save mode after receiving the beacon of the plurality of beacons and before transmitting the response to the beacon sending device.

7. The method of claim 6, wherein the power save mode is the low power mode.

8. The method of claim 1, wherein the beacon sending device enters the reception state between sending sequential beacons.

9. The method of claim 8, wherein the beacon receiving device transmits the response while the beacon sending device is in the reception state immediately after the received beacon.

10. A method of network communications, comprising:
a beacon receiving device exiting a low power mode at a time within a predetermined time interval in which a beacon receiving device exits a low power mode to receive a beacon of the plurality of beacons, and wherein, before the time, a beacon sending device does not know when the beacon receiving device will exit the low power mode;
the beacon receiving device receiving a beacon of a plurality of beacons transmitted by the beacon sending device for the beacon receiving device during the predetermined time interval;
the beacon receiving device transmitting the response to the beacon sending device while the beacon sending device is in a reception state to receive a response from the beacon receiving device to the received beacon of the plurality of beacons; and
the beacon receiving device re-entering the low power mode.

11. The method of claim 10, wherein each beacon of the plurality of beacons includes an identifying index.

12. The method of claim 11, wherein the beacon receiving device transmits the response after the predetermined time interval.

13. The method of claim 12, wherein the beacon receiving device enters a power save mode after receiving the beacon of the plurality of beacons and before transmitting the response to the beacon sending device.

14. The method of claim 10, wherein the beacon receiving device transmits the response while the beacon sending device is in the reception state immediately after the received beacon and before the beacon sending device transmits a next beacon.

15. A method of network communications, comprising:
a beacon sending device transmitting a plurality of beacons for the beacon receiving device during a predetermined time interval in which a beacon receiving device exits a low power mode to receive a beacon of the plurality of beacons at a time within the predetermined time interval, and wherein, before the time, a beacon sending device does not know when the beacon receiving device will exit the low power mode;
the beacon sending device entering a reception state to receive a response from the beacon receiving device to a received beacon of the plurality of beacons; and
the beacon sending device receiving the response.

16. The method of claim 15, wherein each beacon of the plurality of beacons includes an identifying index.

17. The method of claim 16, wherein the beacon sending device enters the reception state after the predetermined time interval.

18. The method of claim 15, wherein the beacon sending device enters the reception state between sending sequential beacons.

19. A beacon receiving device, comprising:
a transceiver module comprising a non-transitory computer readable medium, the computer readable medium including instructions for causing the beacon receiving device to perform the steps of:
the beacon receiving device exiting a low power mode at a time within a predetermined time interval in which a beacon receiving device exits a low power mode to receive a beacon of the plurality of beacons, and wherein, before the time, a beacon sending device does not know when the beacon receiving device will exit the low power mode;
the beacon receiving device receiving a beacon of a plurality of beacons transmitted by the beacon sending device for the beacon receiving device during the predetermined time interval;
the beacon receiving device transmitting the response to the beacon sending device while the beacon sending device is in a reception state to receive a response from the beacon receiving device to the received beacon of the plurality of beacons; and
the beacon receiving device re-entering the low power mode.

20. The apparatus of claim 19, wherein each beacon of the plurality of beacons includes an identifying index.

21. The apparatus of claim 20, wherein the instructions cause the beacon receiving device to transmit the response after the predetermined time interval.

22. The apparatus of claim 21, wherein the instructions cause the beacon receiving device to enter a power save mode after receiving the beacon of the plurality of beacons and before transmitting the response to the beacon sending device.

23. The apparatus of claim 19, wherein the instructions cause the beacon receiving device to transmit the response while the beacon sending device is in the reception state immediately after the received beacon and before the beacon sending device transmits a next beacon.

24. A beacon sending device, comprising:
a transceiver module comprising a non-transitory computer readable medium, the computer readable medium including instructions for causing the beacon sending device to perform the steps of:
the beacon sending device transmitting a plurality of beacons for the beacon receiving device during a predetermined time interval in which a beacon receiving device exits a low power mode to receive a beacon of the plurality of beacons at a time within the predetermined time interval, and wherein, before the time, a beacon sending device does not know when the beacon receiving device will exit the low power mode;
the beacon sending device entering a reception state to receive a response from the beacon receiving device to a received beacon of the plurality of beacons; and
the beacon sending device receiving the response.

25. The apparatus of claim 15, wherein each beacon of the plurality of beacons includes an identifying index.

26. The apparatus of claim 16, wherein the instructions cause the beacon sending device to enter the reception state after the predetermined time interval.

27. The apparatus of claim 15, wherein the instructions cause the beacon sending device to enter the reception state between sending sequential beacons.
